(19) United States
(12) Patent Application Publication
(10) Pub. No.: US 2016/0055774 A1
(43) Pub. Date: Feb. 25, 2016

(54) TOOL IDENTIFICATION AND ORGANIZATION SYSTEM

(71) Applicants: Anthony Manos, Frankfort, IL (US); Jennifer Molski, Frankfort, IL (US)

(72) Inventors: Anthony Manos, Frankfort, IL (US); Jennifer Molski, Frankfort, IL (US)

(21) Appl. No.: 14/825,358

(22) Filed: Aug. 13, 2015

Related U.S. Application Data
(60) Provisional application No. 62/040,084, filed on Aug. 21, 2014.

(51) Int. Cl. G09F 3/10; G09F 3/02; B25H 3/04

(52) U.S. Cl. CPC G09F 3/10; B25H 3/04; G09F 3/02; G09F 2003/0264

(57) ABSTRACT

A method and system for organizing and maintaining such organization of a plurality of uniquely-shaped objects, such as hand tools, in a work environment. Overlays of a thin, flexible material are cut from a sheet to resemble specific tools in size and shape. The overlays are then affixed (either permanently or temporarily) onto a display surface and retention members, such as hooks, pegs, or the like, may also be added to the surface, if needed. The retention members hold the uniquely-shaped objects, e.g., tools, onto the display surface for easy location and ready use. Tool IDs matching the coding of the overlays are adhered to the objects for a specific station, especially where multiple stations are involved.

### RELATED APPLICATION

The present application claims the filing priority of U.S. Provisional Application No. 62/040,084 titled “Tool Organization System” and filed on Aug. 21, 2014. The '084 application disclosure is hereby incorporated by reference.

### TECHNICAL FIELD OF THE INVENTION

The present application relates to systems and methods for organizing tools. Not just mechanic tools, like wrenches, hammers, screwdrivers, and the like, but tools for almost any trade, business and profession.

### BACKGROUND OF THE INVENTION

Professionals and businesses which rely on the use of more than a few tools probably experience a similar problem from time to time. That is, the problem of how to best keep tools organized, identifiable and readily accessible to themselves or other users. The problem is not limited to any particular trade either. Rather, it extends to businesses of all types, whether the “tools” are comprised of a framer's hammer, saw, tape measure, and the like, a mechanic's wrenches, sockets, screwdriver, etc., or a crafter's scissors, tape, utility knife and glue gun.

To solve this problem, some businesses use special divided drawers, sometimes including labels. However, the tools are then stowed or hidden away and are not always easily accessible. Drawers can also become stuck due to misplaced tools, and drawers tend to require a box, bench or chest which may take up valuable floor space.

Another solution requires hanging tools on a vertical peg-board. While this solves the hidden tools and floor space problems, it fails to address critical organization issues. The placement of tools on a peg-board is often random and haphazard. As a result, it can become difficult to find a specific tool when needed.

A system for organizing tools is needed. A system which allows tools to be easily stored and easily retrieved. A system which in certain embodiments may not utilize significant floor space. In other embodiments the system may make more effective use of floor and/or other horizontal storage space (e.g., work bench, counters, etc.). A system which promotes and facilitates repeatable organization so that a tool can always be found in the same location.

These and other problems are addressed by the present system and methods to provide a system with numerous advantages in organization, implementation and overall effectiveness.

### SUMMARY OF THE INVENTION

The purpose of this invention is to overcome the shortcomings of method employed by those in various fields for identifying and organizing a specific set of tools, as mentioned above. The present system and methods allow a user to code each tool with a plurality of tool sets or in just a single tool set to a specific workstation or even a specific location (e.g., drawer or wall-board) within a workstation.

Generally speaking, the system includes a first substrate comprised of flexible material having a plurality of unique-shapes precut thereon to be easily removed from the substrate as overlays, and a display surface, wherein the overlays are capable of being adhered to the display surface once removed from the substrate. Preferably, at least some of the unique-shapes are precut to resemble a specific set of tools, while other of the shapes may be precut as station markers.

In an expanded embodiment, the tool identification and organization system includes a plurality of additional substrates comprised of flexible material having a plurality of unique-shapes precut thereon to be easily removed from the substrate as additional overlays. This allows the system to be used to organize and identify multiple sets of similar tools.

In an embodiment, the first substrate and the plurality of additional substrates are coded to be distinguished from one another. The substrates may be color, letter, number or symbol coded.

In an embodiment, the unique-shapes preferably include an adhesive applied to one side for adhering to the display surface. In other embodiments the unique-shapes are comprised of a vinyl polymer which clings to the display surface.

Generally speaking, the method for identifying and organizing uniquely-shaped objects in a work environment comprises the steps of cutting corresponding uniquely-shaped patterns from a sheet of flexible material, adhering the uniquely-shaped patterns to a display surface, attaching a retention member, such as a hook or peg, proximate each uniquely-shaped pattern on the display surface, and placing each object onto the display surface via the retention member aligned proximate the corresponding uniquely-shaped pattern.

These and other embodiments will be more readily apparent from a review of the following detailed description and the appended drawings referenced therein.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is an illustration of one possible embodiment of the present invention as it is applied to a board for storing a plurality of standard tools;

FIG. 2 is an illustration of a simple five-piece silhouette tool station using letter-coding to visually distinguish from other similar tool stations;

FIG. 3 is the tool station of FIG. 2 showing the placement of corresponding letter-coded tools, including an improper letter-coded utility knife being clearly misplaced;

FIG. 4 is another illustration of coded tool work station;

FIG. 5 is the tool station of FIG. 4 showing the placement of corresponding coded tools; and

FIG. 6 is still another illustration of a color-coded tool station.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

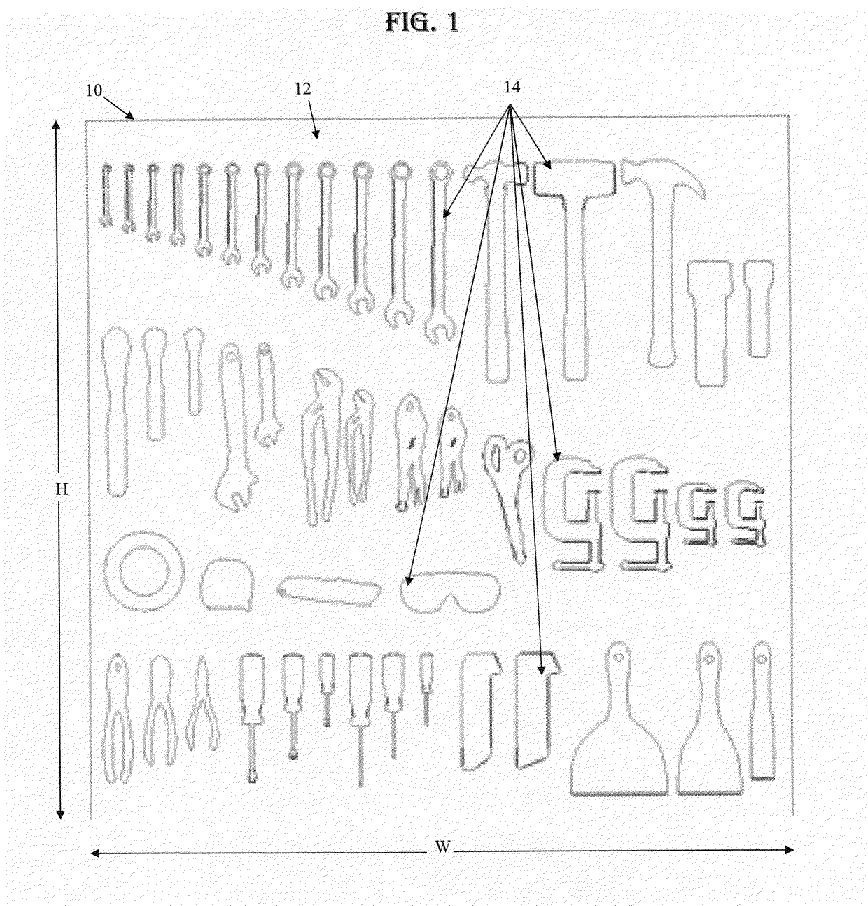

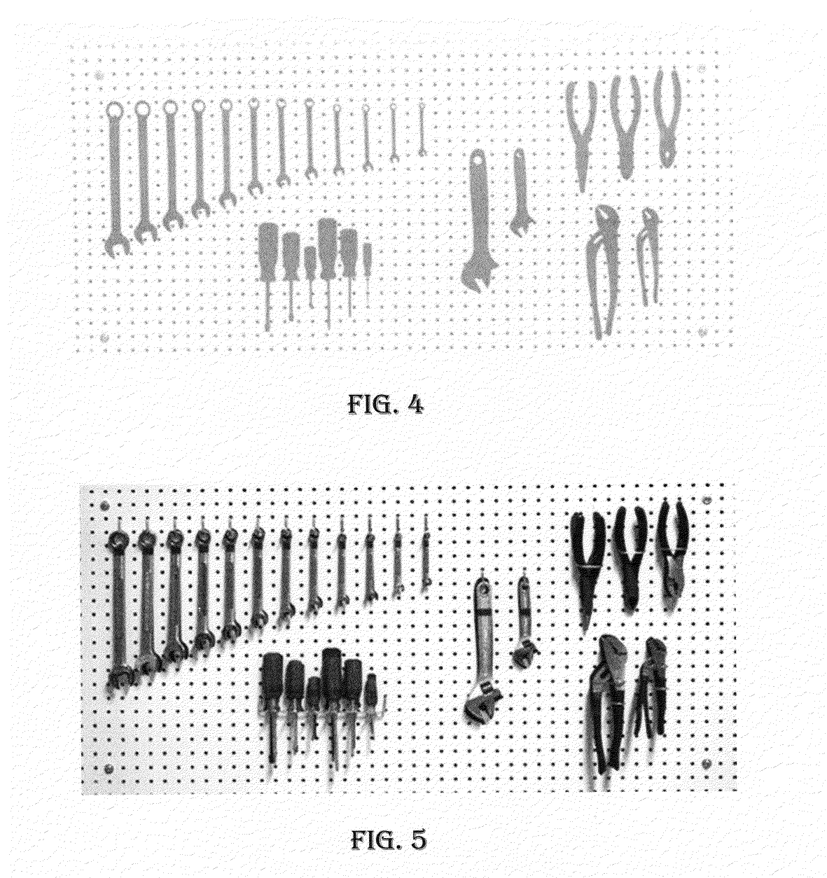

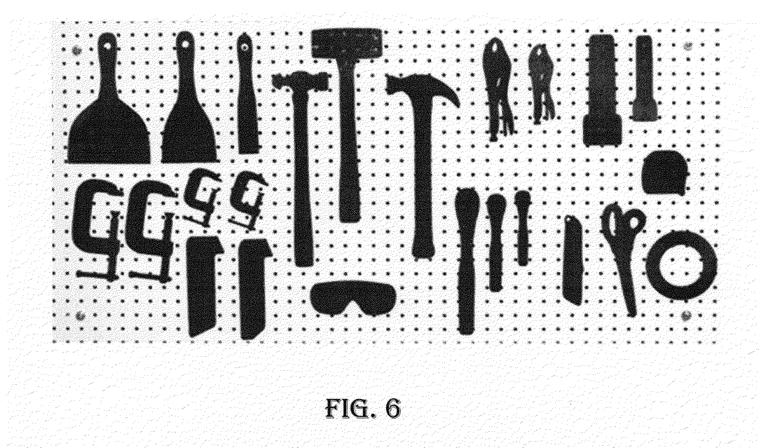

Referring now to FIGS. 1-6, there is illustrated a peg board 10 having a height (H) and a width (W). Adhered to the surface 12 of the peg board 10 is a plurality of tool silhouettes (or overlays) 14. These silhouettes 14 are sized and shaped to closely resemble specific hand tools—e.g., open end and box end wrenches, ball peen hammer, claw hammer, C-clamps, Phillips and flathead screwdrivers, adjustable wrenches, scissors, ratchet drivers, channel locks, etc. At each specific silhouette is an appropriate retention member 16 (e.g, a peg or hook) from which an appropriate tool can be temporarily retained.

Alternatively, in other uses (not shown), the silhouettes can also be used on a bench top, a table top, a desk top, or in a drawer. For example, a silhouette for a cordless drill, a table saw, a specific hardware container, or the like, may be adhered to a horizontal surface of a work station to indicate each item's proper location on that surface. In such uses, no engagement member may be necessary.

In a preferred embodiment, the silhouettes 14 are adhered to a peg board 10 in any known manner. For example, they may be permanently affixed using an adhesive applied to the board or one side of the silhouettes, or they may be held by static cling. Preferably, the silhouettes are cut from a sheet of outdoor grade polyvinyl material, but other durable plastic films may also be suitable. Typically, the polyvinyl materials have a tendency to cling to surfaces and may be attached with little to no adhesive.

The silhouettes can be sold in “ready-to-apply” sheets/substrates having precut shapes based on a particular tool manufacturer's specifications. This will allow the silhouettes to include any noticeable trademark or trade dress characteristics in the tools (e.g., handle style), if desired.

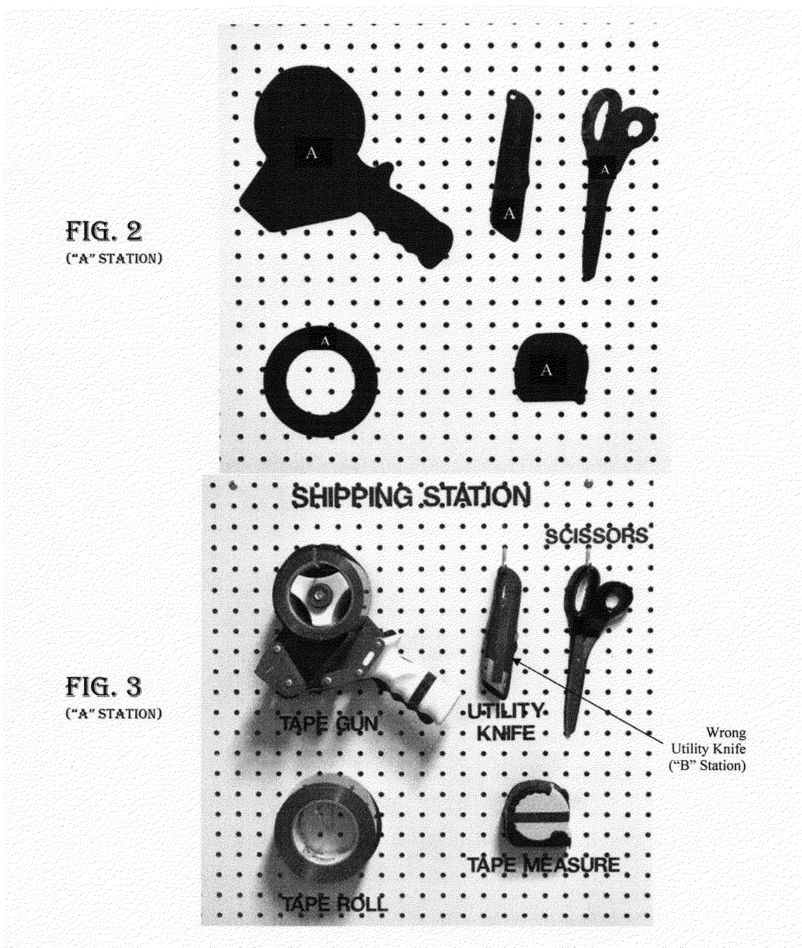

Another potential feature of the system is that the silhouettes 14 may be coded to add another level of organization, as illustrated in FIGS. 2-5. That is, where more than one set of tools exist in a workplace, coded tool stations can be created. Each tool station would have a display board 10 with a different set of coded silhouettes applied. The coding feature of the different silhouettes may be done using color, shading, letters/numbers, symbols, or any other visually distinguishable marking. The resulting coded tool stations (e.g., blue station, green station, “A” station, “B” station, etc.) make it even easier to keep track of, identify and organize many tool sets.

Further, as part of the precut film silhouettes provided, small coded tool IDs (e.g., strips or dots) can also be included for each tool. For example, every tool from the “A” tool station would have an easily identifiable “A” ID adhered thereto. Likewise, tools from a “B” tool station would all have an easily identifiable “B” tool ID applied in a viewable location on the tool (e.g., the handle). Even a person completely unfamiliar with the particular tools could easily organize the marked tools at the end of a shift by merely placing all “A” coded tools at the “A” tool station, all the “B” coded tools at the “B” tool station, and so forth. Then, by merely matching a tool shape with a corresponding silhouette 14 on the peg board 10 at each station, the tools can be easily organized and stored for later use. This concept works equally well with numbers, symbols, colors, shadings, and the like.

FIG. 2 shows an “A” tool station set up for a tape gun, a tape roll, a tape measure, a utility knife and a pair of scissors. FIG. 3 shows these five “tools” (or items) stored at their corresponding silhouettes. Each tool has a corresponding “A” code applied, with the exception of the utility knife which is affixed with a “B” code. Clearly the “B” utility knife is misplaced on the “A” station and can be easily identified and returned to the proper station.

As stated above, the illustrated example is for a number of standard hand tools and related items (e.g., tape roll, measuring tape, goggles, etc.). However, the invention has applications in most any industry where numerous tools are used and remain on-site, especially specialty/custom tools. Further, the organization system is not necessarily limited to tools, but may be applicable to tool parts (e.g., saw blades) and other commonly displayed and uniquely-shaped items (e.g., replacement parts for a machine).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A tool identification and organization system comprising:
a first substrate comprised of flexible material having a plurality of unique-shapes precut thereon to be easily removed as overlays from the substrate; and
a display surface, wherein the overlays are capable of being adhered to the display surface once removed from the substrate;
wherein at least some of the unique-shapes are pre-cut to resemble a specific set of tools.

2. The tool identification and organization system of claim 1, further comprising a plurality of additional substrates comprised of flexible material having a plurality of unique-shapes precut thereon to be easily removed from the substrate as additional overlays.

3. The tool identification and organization system of claim 2, wherein the overlays and the plurality of additional overlays are coded to be distinguished from one another.

4. The tool identification and organization system of claim 3, wherein the overlays and additional overlays are color coded.

5. The tool identification and organization system of claim 1, wherein the overlays and additional overlays include an adhesive applied to one side for adhering to the display surface.

6. The tool identification and organization system of claim 1, wherein the overlays and additional overlays are comprised of a vinyl polymer which clings to the display surface.

7. The tool identification and organization system of claim 1, wherein the display surface comprises peg board.

8. The tool identification and organization system of claim 1, wherein the display surface comprises a tool drawer.

9. The tool identification and organization system of claim 1, further comprising precut station identification labels.

10. A method for organizing a plurality of uniquely-shaped objects, the method comprising the steps of:
cutting corresponding uniquely-shaped overlays from a sheet of flexible material;
adhering the uniquely-shaped overlays to a display surface;
cutting an identification label from the sheet of flexible material for each uniquely-shaped object;
affixing an identification label to each object, wherein the uniquely-shaped overlays and the identification labels are similarly coded; and
placing each similarly coded object onto the display surface aligned proximate the corresponding uniquely-shaped overlay.

11. The method of claim 10, wherein the step of placing each object onto the display comprises the steps of:
attaching a retention member, such as a hook or peg, proximate each uniquely-shaped overlay on the display surface; and
engaging each object with the retention member proximate the corresponding uniquely-shaped overlay.

12. The method of claim 10, further comprising the step of repeating the cutting, adhering, cutting, affixing, and placing steps for each of a plurality of workstations.

13. The method of claim 11, further comprising the step of repeating the cutting, adhering, cutting, affixing, attaching, and engaging steps for each of a plurality of workstations.
